(19) United States
(12) Patent Application Publication
(10) Pub. No.: US 2006/0178047 A1
(43) Pub. Date: Aug. 10, 2006

(54) RJ "F", MODULAR CONNECTOR FOR COAXIAL CABLES

(76) Inventor: QUINN F CROAN, PHOENIX, AZ (US)

Correspondence Address: QUINN F CROAN, 5533 E. PINCHOT AVE, PHOENIX, AZ, 85018, US

(21) Appl. No.: 11/306,543

(22) Filed: Dec. 31, 2005

Related U.S. Application Data
(63) Continuation of application No. 10/906,192, filed on Feb. 8, 2005, now Pat. No. 6,955,563.
(63) Continuation of application No. 11/163,200, filed on Oct. 10, 2005, now Pat. No. 7,021,964.

(51) Int. Cl. H01R 9/05

(52) U.S. Cl. 439/578

(57) ABSTRACT

A connector employing a plug assembly and socket assembly for coaxial cables having apertures, conductive elements, mating surfaces and locking mechanisms to maintain the electrical characteristics of the cable joined to the plug assembly, to hold the plug and socket physically in connection with one another, and to establish and maintain the electrical characteristics of the cables through the connector assembly. The plug is configured to attach to a coaxial cable in such a manner that: a) the center conductor of the coaxial cable extends through the plug assembly for engagement with mating conductors in the socket, and b) such that the shield of the cable is physically and electrically engaged by a conductive element extending through the plug which contacts the conductive elements within the socket. These two features establish electrical contact of the shield and center conductor into and through the connector. The connector includes a socket assembly having a receiving aperture formed therein for receiving the plug assembly. The socket assembly when configured for a cable-to-cable connection accepts a plug assembly at opposing ends and is configured to extend electrical connection between the inner and outer conductors of the coaxial cables when a plug is received in each of the receiving apertures; or, in the modified form, for connecting the coaxial cable to terminal equipment; or, in the second modified form, for adapting a standard male threaded connector to a socket assembly; or in the third modified form, for adapting a standard female threaded connector to a plug assembly; or in an alternate form of the invention, to provide a plug adaptor permitting use of the invention with cables having inner conductors that are insufficiently rigid for unaided use with the preferred and modified forms of the invention. The socket assembly includes an outer conductor element that is electrically isolated from inner conductive elements of the socket assembly that provide electrical continuity for the inner conductor of the cables. The connector assembly may incorporate a compressible conductive element placed at the junction of the outer conductors of the plug and socket. The outer conductor and inner conductor of the plug assembly and socket assembly are electrically connected when the plug is received in the receiving aperture. The plug and socket assemblies incorporate a snap-fit, locking mechanism to retain the plug and socket assemblies in mechanical and electrical connection with each other.

### BACKGROUND OF THE INVENTION

This invention relates to fittings for connecting coaxial cables together, to connecting coaxial cables to terminal devices and to adapters for converting cables with traditional connectors for use with this improved connector. This invention further relates to improvements in the physical properties and mating characteristics of end connectors in RJ type modular connectors as used for establishing and maintaining a mechanical and electrical connection in a modular arrangement that incorporates a locking mechanism. This invention also relates to reducing the number of unique or different connector types or components required in providing a complete connector system for use in applications using coaxial cables.

Coaxial cables are generally characterized by being made up of inner and outer concentric conductors (or inner conductor and shield respectively) separated by a dielectric insulator, with some cables being encased or covered by a protective outer jacket of rubber or rubber-like material. Numerous types of end connectors have been devised to effect a secure mechanical and electrical connection to the end of the coaxial cable, which provide for connecting coaxial cables to other coaxial cables, and for connecting coaxial cables to various terminal devices while maintaining the electrical characteristics of the cable or cables.

The current invention provides further refinements to my earlier invention, U.S. Pat. No. 6,955,563, RJ TYPE MODULAR CONNECTOR FOR COAXIAL CABLES, issued on Oct. 18, 2005, and the continuation of said patent in patent application Ser. No. 11/163,200 filed on Oct. 18, 2005 for RJ “F”, MODULAR CONNECTOR FOR COAXIAL CABLES, which application was allowed in November 2005.

Prior art coaxial connectors as invented by Croan include a plug and socket arrangement using conductive sleeves, the plug having a tapered cone and the socket having a complementary tapered counterbore thereby providing mating surfaces for establishing an electrical path for the outer conductors of the coaxial cable when plug and socket are mated together. The conductive path for the inner conductors of coaxial cables is established through a center conductive element employing either conductive prongs or a slotted counterbore. This modular type connector includes a socket assembly having a mating cavity configured to accept and mate with external guide surfaces of a plug assembly guiding the conductive elements into proper alignment for mating and effecting mechanical engagement and electrical conductivity of inner and outer conductors.

One problem with Croan's prior modular type coaxial connector is in the number of unique and complex parts required to provide a connector system for use with coaxial cables. The requirements of manufacturing a greater number of system components leads to a higher unit cost, thereby increasing overall system costs.

A further, related problem is how the configuration as employed tends to increase the physical size of the overall connector system, which limits the application of this system in confined spaces.

Another problem with Croan's prior connector stems from the need for connecting the two connector elements, i.e.-plug and socket, directly to a cable. This leads to unique, different cable preparation requirements for affixing each element to a cable.

Yet another problem with Croan's prior connector is the need for a “blind” mating of a cable to the socket assembly. This feature of the RJF modular connector assembly potentially leads to a higher number of improperly installed connectors requiring removal and re-installation of the socket assembly, thereby wasting installation time and, potentially, the cost of a socket connector.

Yet another problem with Croan's connector is that it requires a cable to have a sufficiently rigid center conductor, so as to maintain proper alignment while being inserted into the plug assembly and/or socket assembly. Many coaxial cables are not able to satisfy this requirement.

It is, therefore, an object of the present invention to overcome the above problems and others by providing a coaxial cable connector which can be easily connected directly to a cable, and that provides a removable connection between a pair of coaxial cables, or between a coaxial cable and a terminal device while sustaining electromagnetic shielding of a signal conveyed within the coaxial cable(s). Still other objectives of the present invention will become apparent to those of ordinary skill in the art upon reading and understanding the following detailed description.

### SUMMARY OF INVENTION

Accordingly, I have invented a novel and improved modular connector for positively splicing cables together, connecting cables at wall plates, connecting coaxial cables to terminal equipment, adapting traditional connectors to a modular plug and socket arrangement, and providing an adaptor for use with cables having flexible center conductors.

The objective of the present invention is to provide a plug assembly that attaches directly to the prepared end of a coaxial cable, which is used in conjunction with a socket assembly that employs a snap-fit, locking mechanism for maintaining said plug and socket assemblies in mechanical and electrical connection when mated together.

It is another object of the present invention to provide for a socket assembly wherein the socket conductive sleeve is generally fixed within the socket body.

It is another object of the present invention to provide for a socket assembly wherein the socket assembly will receive two plug assemblies.

It is another objective of the present invention to provide for a plug assembly wherein the plug conductive sleeve may either be: generally fixed within the plug body, or longitudinally movable within the plug body.

It is another objective of the present invention that the connector assembly herein proposed be capable of effecting sealed engagement with one end of a coaxial cable and of being interchangeable for use with coaxial cables of different sizes and/or different impedances.

It is the further object of the present invention to provide a plug and socket that meets or exceeds the electrical performance parameters of connectors currently in use.

It is yet another object of the present invention to provide for a connector adapter assembly for coaxial cables that will adapt cables or devices having traditional threaded connectors for use with the modular plug and socket arrangement utilizing the snap-fit, locking mechanism features of this invention and fully incorporating the modified features of the present invention as herein provided.

It is yet another objective of the present invention to provide for a center conductor adaptor that provides sufficient support and rigidity, while maintaining the other relevant electrical properties, for use with this modular plug and socket connector assembly when the diameter of and/or the material used for the inner conductor of a cable is insufficiently rigid to effect a good electrical connection.

It is yet another objective of the present invention to fully incorporate the current improvements with the benefits and features of the prior art.

In accordance with the present invention, a modular connector assembly has been devised for connecting an end of a coaxial cable to a plug assembly wherein the cable is a standard cable having radially inner and outer generally cylindrical conductors separated by an annular dielectric, and in some cases, an outer tubular jacket of rubber or rubber-like material encasing the outer conductor and with a portion of both the inner and the outer conductor being exposed at the end of the cable. Said connector assembly includes a socket assembly configured to connect two cables that are equipped with complimentary plug assemblies to one another.

Due to the wide variety of cables, cable types and cable sizes, and the vast number of mechanisms used to secure a connector to such cables, any of which may be employed with the novel elements of this invention, only one mechanism for securing a cable to the novel elements of this invention will be depicted herein. However, this limited depiction is only used to simplify review of the novel elements of my invention and is not intended to restrict or limit the use of the novel elements of this invention with other mechanisms for securing a cable to the connector.

The plug is comprised of radially inner and outer spaced conductors wherein the inner conductor is formed by the inner conductor of the coaxial cable and extends through a conductive sleeve, this sleeve being sized for insertion of the outer conductor and jacket, if any, through one end of the connector between the inner and outer sleeves, engaging an external surface of the jacket only when the cable is fully inserted into the connector and the outer sleeve is deformed radially inwardly until the effecting sealed engagement with the outer conductor, and jacket if any. The socket connector is complementary to the plug connector for connecting the cable to the socket.

The conductive sleeve of the plug may be mounted into a dielectric casing that is formed to provide the retaining mechanism for the plug and to provide for physical mating with a complementary socket aperture. Alternatively, the plug may be a single piece formed of conductive material, or a single piece formed of a dielectric material with conductive material deposited on appropriate surfaces. The conductive sleeve may be generally fixed within the plug housing or may be longitudinally movable within the plug housing, in which case a tensioning device is employed to provide longitudinal pressure, keeping the plug conductive sleeve in mechanical and electrical engagement with the complimentary socket conductive sleeve.

The plug conductive sleeve may include a compressible conductive element that is positioned within the tapered counterbore of the conductive sleeve and may be permanently or semi-permanently attached thereto. Alternatively, the compressible conductive element may be positioned in the socket assembly as described below.

The socket assembly is comprised of radially inner and outer spaced conductors wherein the inner conductor is a conductive element employing a central conductive element having either conductive prongs or slotted counterbores for receiving and establishing mechanical and electrical engagement with the plug center conductor when plug and socket are mated together. The socket inner conductive element is equipped for engagement with a plug center conductor at the two opposing ends thereof.

A conductive sleeve within the socket is sized to accept the socket inner conductive element and a dielectric material which positions the inner conductor within conductive sleeve, with all elements being sized and shaped, and with the materials used being selected, to maintain the characteristic impedance of the cable in question. The plug connector is complementary to the socket connector for connecting the cable to the plug.

The conductive sleeve of the socket may be mounted into a dielectric casing that is formed so as to provide the complementary retaining mechanism and aperture for receiving the plug and to provide for physical mating with a complementary plug assembly at two ends thereof. Alternatively, the socket may be a single piece formed of conductive material, or a single piece formed of a dielectric material with conductive material deposited on appropriate surfaces.

The socket conductive sleeve may include a compressible conductive element that is positioned upon the tapered cone of the conductive sleeve and may be permanently or semi-permanently attached thereto. Alternatively, a compressible conductive element may be positioned in the plug assembly as described above.

In preferred and modified forms of the invention, any of a variety of methods may be used to effect sealed engagement between the cable and the plug assembly. The method shown in preferred and modified forms of the invention is not a novel aspect of the current invention, neither is it the only method, consistent with the state of the art, for attaching the plug to the end of a cable, and does not in any way limit or restrict using the novel aspects of the current invention with regards to other methods of attachment.

The terminal connector has a socket that serves to facilitate connection of the plug connector assembly to a terminal. The terminal connector employs a socket assembly suitable for insertion of a plug assembly, while further providing points of attachment to the inner and outer conductors of the socket assembly for connection to the electrical circuitry of the terminal.

The terminal and cable adaptors have either a socket or a plug with a threaded connection to facilitate attachment of a plug or socket end connector to a terminal, device or cable equipped with standard threaded connectors. The terminal adaptor employs a threaded female connection that threadedly mates to a standard male threaded connector, while providing a socket assembly suitable for mating with a complementary plug assembly, with the threaded portions providing a connection for the outer conductor and provision made for extending the center conductor to effect a connection within the standard threaded male connector. The cable adaptor employs a threaded male connection that threadedly mates to a standard female threaded connector, while providing a plug assembly suitable for mating with a complementary socket assembly, with the threaded portions providing a connection for the outer conductor and provision made for receiving the center conductor to effect a connection within the female cable adaptor.

The plug adaptor employs a center conductor adaptor that provides sufficient rigidity to the inner conductor of a cable when a high degree of flexibility in the inner conductor of a cable does not permit the use of an RJF Modular Coaxial Cable Connector. The center conductor adaptor employs a conductive element centrally mounted within a generally disk shaped insulator. The conductive element contains a central longitudinal opening for receiving a flexible cable inner conductor and provides sufficient length and rigidity, when assembled with a modular plug, to permit insertion and electrical connection within a socket assembly.

The above and other objects of the present invention will become more readily appreciated and understood from a consideration of the following detailed description of preferred and modified forms of the present invention when taken together with the accompanying drawings in which:

### BRIEF DESCRIPTION OF THE DRAWINGS

FIG. 1 is a longitudinal cross-sectional view illustrating the preferred form of the invention for connecting two cables together;

FIG. 2 is a longitudinal cross-sectional view illustrating one form of the plug assembly of the invention assembled onto a coaxial cable;

FIG. 2a is a longitudinal cross-sectional view of the invention shown in FIG. 2 displaying only the conductive sleeve of the plug assembly without a cable inserted;

FIG. 2b is a longitudinal cross-sectional view of the of the invention shown in FIG. 2, displaying only the plug body of the plug assembly;

FIG. 3 is a longitudinal cross-sectional view illustrating an alternate form of the plug assembly of the invention assembled onto a coaxial cable;

FIG. 3a is a longitudinal cross-sectional view of the invention shown in FIG. 3 displaying only the conductive sleeve of the plug assembly without a cable inserted;

FIG. 3b is a longitudinal cross-sectional view of the of the invention shown in FIG. 3 displaying only the plug body of the plug assembly;

FIG. 4 is a longitudinal cross-sectional view displaying one form of the socket assembly of the invention as used for connecting two cables together;

FIG. 4a is a longitudinal cross-sectional view of the invention shown in FIG. 4 displaying the conductive sleeve of the socket assembly;

FIG. 4b is a longitudinal cross-sectional view of the of the invention shown in FIG. 4 displaying only the socket body of the socket assembly;

FIG. 5 is a longitudinal cross-sectional view displaying an alternate form of the socket assembly of the invention as used for connecting two cables together;

FIG. 5a is a longitudinal cross-sectional view of the invention shown in FIG. 5 displaying only the conductive sleeve of the socket assembly;

FIG. 5b is a longitudinal cross-sectional view of the of the invention shown in FIG. 5 displaying only the socket body of the socket assembly;

FIG. 6 is a longitudinal cross-sectional view of a modified form of the invention for connecting a coaxial cable to terminal, or other equipment, wherein the socket assembly is configured to provide points of access to the inner and outer conductors for connection to the electrical circuitry of the terminal equipment;

FIG. 7 is a longitudinal cross- sectional view of a modified form of the invention for adapting a standard male threaded connector to a socket connector to receive a cable having a complimentary plug assembly;

FIG. 8 is a longitudinal sectional view of a modified form of the invention for adapting a standard female threaded connector, such as is used on cables, to a plug assembly ready for mating with a complimentary socket assembly;

FIG. 9 is a longitudinal cross-sectional view of a modified form of the invention employing a center conductor adaptor, shown assembled onto a cable and into a plug assembly;

FIG. 9a is a longitudinal cross-sectional view of the center conductor adaptor shown in FIG. 9;

FIG. 9a is a front view of the center conductor adaptor shown in FIG. 9

### DETAILED DESCRIPTION OF PREFERRED EMBODIMENT

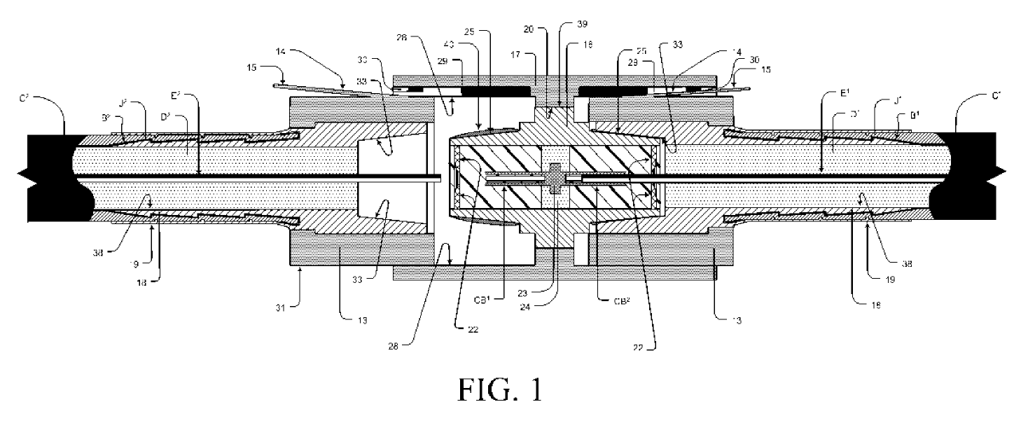

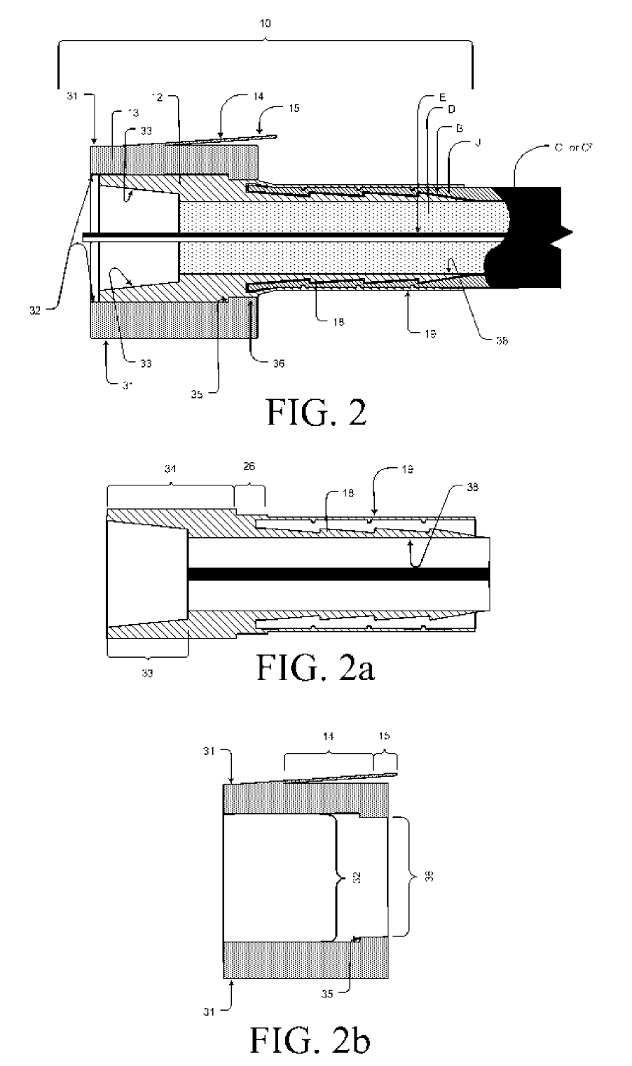

Referring in more detail to the drawings, there is shown by way of illustrative example in FIGS. 1, 2, 2a, 2b, 3, 3a, 3b, 4, 4a, 4b, 5, 5a and 5b, a plug assembly 10 and a socket assembly 11 for positively interconnecting conventional forms of coaxial cables C¹ and C². In this application, two plug assemblies are assembled, one each onto coaxial cables C¹ and C², providing the means for engaging with socket assembly 11, which employs two mating cavities, one at each end of the socket assembly.

As a setting for the present invention, inner and outer sleeves, 18 and 19 of plug assembly 10, are of a type employed in existing screw type and push type connectors, and form the components of said connectors that capture a coaxial cable in the connector. These elements, as shown in preferred and alternate forms of the invention, are included for the purpose of illustration only and therefore indicate only one of the many viable methods for directly connecting the novel portions of the invention directly to a cable, which, by providing for direct connection to the plug assembly is, in and of itself, a novel element of the current invention.

The plug assembly 10 is broadly comprised of a plug body 13, having a locking tab 14 with release tab 15, and with bore 32 and bore 36 into which plug conductive sleeve 12 is inserted. Plug assembly 10 is further comprised of plug conductive sleeve 12 having a central bore 38, tapered counterbore 33, cylindrical element 34, cylindrical element 26, inner sleeve 18 and outer sleeve 19. Plug conductive sleeve 12 is inserted into plug body 13 through bore 32 and bore 36, which are sized and shaped complimentary to cylindrical element 34 and cylindrical element 26 of plug conductive sleeve 12, such that when conductive sleeve 12 is fully seated in plug body 13, the shoulder formed on conductive sleeve 12 by cylindrical element 34 and cylindrical element 26 rests against the shoulder formed in plug body 13 by bore 32 and bore 36, identified by leader 35.

Plug body 13 has external outer surface(s) 31 that are complimentary to the internal guiding surface(s) 28 of socket body 17, which complimentary surfaces provide mechanical alignment of plug to socket. (While both plug and socket are herein depicted with four surfaces, the invention may also be implemented using one or more guide surface(s) provided only that plug and socket maintain complimentary surfaces in both shape and number.) When plug assembly 10 is inserted into socket body 17, locking tab 14 is flexed downward to permit insertion, and when fully inserted into socket body 17, locking tab 14 flexes upward returning to its resting position, engaging socket locking cavity 29 such that plug assembly 10 remains in engagement with socket assembly 11 and cannot be withdrawn. Release tab 15 extends outward through locking tab release slot 30 of socket body 17 providing the means of disengaging locking tab 14 from socket locking cavity 29 to accomplish un-mating of plug and socket assemblies. Such disengagement is accomplished by depressing release tab 15, which flexes locking tab 14 downward, disengaging it from socket locking cavity 29, thereby permitting withdrawal of plug assembly 10 from socket assembly 11. The plug-mating cavity formed by bore 32 is configured to receive cylindrical element 27 of socket conductive sleeve 16.

Plug conductive sleeve 12 is formed with tapered counterbore 33 that engages with tapered cone 25 of socket conductive sleeve 16 when plug and socket are mated together. As shown in FIG. 1, 2, 2a and 2b, one variation of plug assembly 10 has conductive element 12 fixed within plug body 13 and is intended for employment with compressible conductive element 40, which is placed between tapered counterbore 33 and tapered cone 25. The conductive property of compressible conductive element 40 in this instance forms part of the conductive path between plug conductive sleeve 12 and socket conductive sleeve 16 formed by the junction of tapered counterbore 33 and tapered cone 25. Compressible conductive element 40 being deformable compresses in a manner that compensates for machining irregularities or other misalignment, thereby ensuring maximum electrical conductivity across this junction under all conditions. The compressible properties of conductive element 40 in this application maintains tension between the plug assembly and socket assembly when mated together. (Although compressible conductive element 40 is depicted as part of socket assembly 11, the invention encompasses the option of incorporating compressible conductive element 40 in this application into plug assembly 10 by being placed within tapered counterbore 33.) Tapered cone 25 and tapered counterbore 33 when mated together provide, through compressible conductive element 40, a conductive path between conductive element 12 and conductive element 16 of plug and socket assemblies 10 and 11, thereby providing an electrical path between the outer conductors of cables C¹ and C².

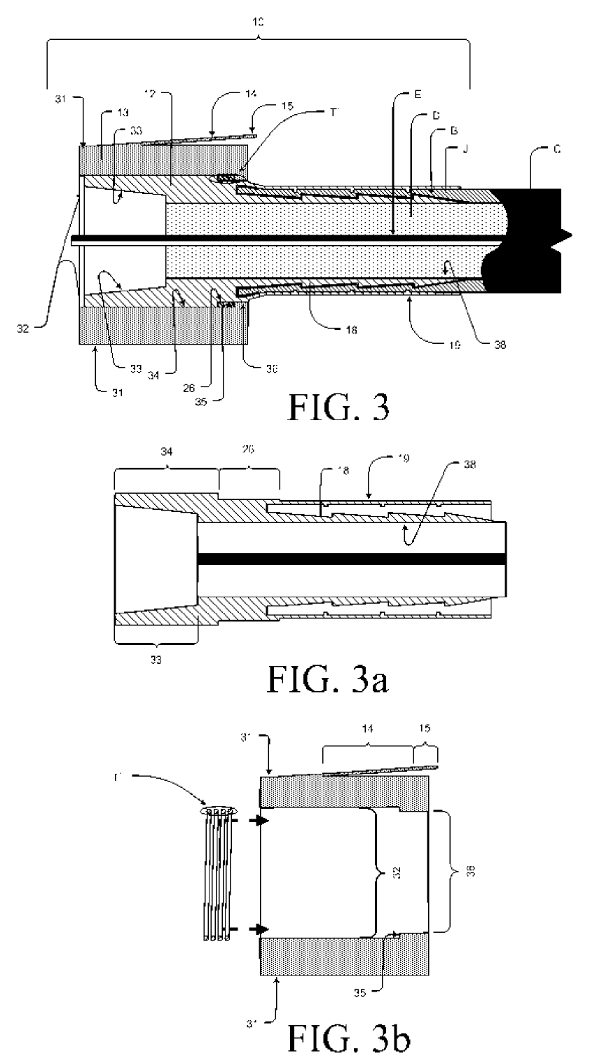

As shown in FIG. 3, 3a and 3b, a variation of plug assembly 10 employs tensioning element T¹, which is positioned in plug body 13 such that tensioning element T¹ maintains forward pressure on plug conductive sleeve 12 which is longitudinally movable within plug body 13. When plug assembly 10 is brought into engagement with socket assembly 11, the action of tensioning element T¹ maintains mechanical and electrical connection between tapered counterbore 33 and tapered conductive cone 25 of conductive element 12 and 16 respectively. In this application, conductivity is established from the outer conductor of a cable through plug conductive sleeve 12 to socket conductive sleeve 16 through tapered conductive counterbore 33 and tapered conductive cone 25. The action of tensioning element T¹, may eliminate the need for compressible conductive element 40, or these two elements may be used in combination for establishing and maintaining a conductive path between plug conductive sleeve 12 and socket conductive sleeve 16. If used, compressible conductive element 40 (if used) being deformable compresses in a manner that compensates for machining irregularities or other misalignment, thereby ensuring maximum electrical conductivity across this junction under all conditions. The compressible properties of conductive element 40 (if used) helps maintain tension between the plug assembly and socket assembly when mated together. (Although compressible conductive element 40 is depicted as part of socket assembly 11, the invention encompasses the option of incorporating compressible conductive element 40 into plug assembly 10 by being placed within tapered counterbore 33.) Tapered cone 25 and tapered counterbore 33 when mated together provide through compressible conductive element 40 (if used), a conductive path between conductive element 12 and conductive element 16 of plug and socket assemblies 10 and 11, thereby providing an electrical path between the outer conductors of cables C¹ and C².

As shown in FIGS. 1, 2, 2a, 2b, 3, 3a and 3b, plug conductive sleeve 12 has an inner sleeve 18 extending rearward from cylindrical element 26 with reduced diameter and wall thickness in relation to cylindrical element 26, and an outer sleeve 19 extending reward from cylindrical element 26. Inner sleeve 18 and outer sleeve 19 are not novel elements of plug assembly 10 and are only included to illustrate one method of directly capturing and retaining coaxial cable C¹ within plug assembly 10 and providing electrical connection between outer conductor B¹ of cable C¹ and conductive sleeve 12 of plug assembly 10. As such, these particular elements may take on various forms, commensurate with current art, in order to accommodate various cable types, cable sizes and cable impedances.

In accordance with conventional practice, the coaxial cables C¹ and C² are made up of an inner conductor E, a dielectric insulator D, outer conductor B and dielectric jacket J, the latter being composed of a suitable rubber or rubber-like compound if present. The inner conductor E is in the form of a pin that is exposed by removing a limited length of the dielectric insulator D, and a limited length of the conductor B is peeled away from the insulator D and doubled over the outer jacket J.

When cable C¹ or C² is inserted into plug conductive sleeve 12, outer conductor B is brought into contact with the outer surface of inner sleeve 18 providing electrical connectivity between cable C¹ and tapered counterbore 33 through conductive sleeve 12. The exposed portion of dielectric D extends through inner sleeve 18 to the inner end of plug conductive sleeve 12, with the exposed portion of inner conductor E extending there from with sufficient length to pass through insulating guide 22 of socket assembly 11 and come into engagement with the central conductive elements of socket assembly 11. With cable C¹ and C² fully inserted, outer sleeve 19 is compressed radially inward to effect sealed engagement between cable C¹ and conductive sleeve 12, or such other methods consistent with the current state of the art are employed for effecting sealed engagement between cable C¹ and C², and a respective plug assembly 10.

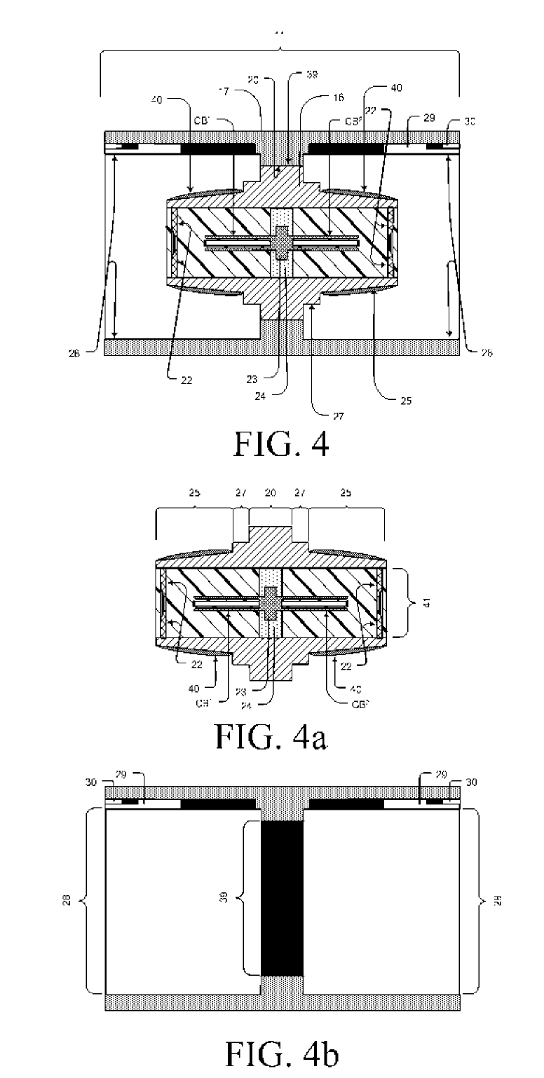

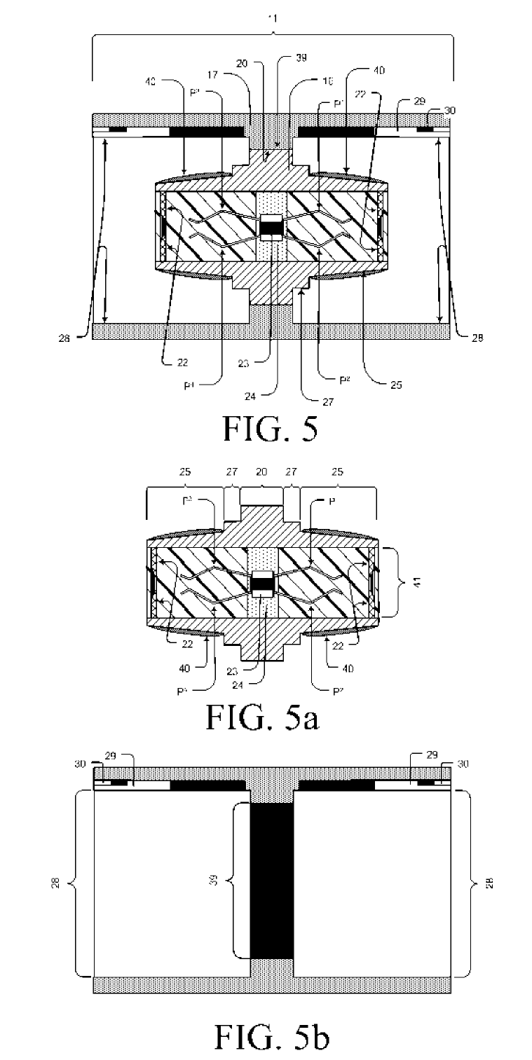

Referring to FIGS. 1, 4, 4a, 4b, 5, 5a and 5b, socket assembly 11 is broadly comprised of a socket body 17, with locking cavity 29 with release tab slot 30, bore 39 into which socket conductive sleeve 16 is inserted and a mating cavity formed by guide surface(s) 28, which features are mirrored at the ends of socket body 17. Socket assembly 11 is further comprised of conductive sleeve 16 having a central bore 41, plug-engaging cylinder 27, tapered cone 25, and cylindrical element 20, which features are mirrored at opposing ends of socket conductive sleeve 16. Within socket conductive sleeve 16 are located two insulating guide rings 22, central conductive element 23 and dielectric 24 for supporting and insulating central conductive element 23 within conductive sleeve 16. FIGS. 4, 4a and 4b depict central conductive element 23 as fitted with slotted counterbores CB¹ and CB² for engaging central conductor E of plug assembly 10 when plug and socket are mated together. Alternately, as shown in FIGS. 5, 5a, 5b, central conductive element 23 may be fitted with conductive prongs, P¹, P², P³, and P⁴ for engaging central conductor E of plug assembly 10 when plug and socket are mated together.

While not depicted as such, compressible conductive element 40 (if used) may be placed within tapered counterbore 33 as discussed above.

Socket body 17 has internal surface(s) 28 recessed into each end that form a mating cavity and that are complimentary to the external outer surface(s) 31 of plug body 13, which and serve to guide plug assembly 10 into a proper mating position with socket assembly 11. (While both plug and socket are herein depicted with four surfaces, the invention may also be implemented using one or more guide surface(s) provided only that plug and socket maintain complimentary surfaces in both shape and number.) When plug assembly 10 is inserted into one end of socket assembly 11, socket-locking cavity 29 receives locking tab 14 such that plug assembly 10 is held in engagement with socket assembly 11 and cannot be withdrawn. Locking tab release slot 30 provides a channel for release tab 15 to extend outward through socket body 17 providing the means of disengaging locking tab 14 from locking cavity 29. In the fully mated position, locking tab 14 maintains plug assembly 10 within socket assembly 11 against the force exerted by compressible conductive element 40 (if used) at the junction between socket conductive sleeve 16 and plug conductive sleeve 12 formed by tapered counterbore 25 and tapered cone 33, and/or the force exerted by tensioning element T¹ of plug assembly 10.

Socket conductive sleeve 16 is formed with plug engaging cylinder 27 that extends into the mating cavity of plug body 13, which cavity is formed by counterbore 32 of plug body 13. Tapered cone 25 of socket conductive sleeve 16 engages with tapered counterbore 33 of plug conductive sleeve 12 when plug and socket assemblies are mated together. Compressible conductive element 40 (if used) maybe placed between tapered counterbore 25 and tapered conductive cone 33 the conductive properties of which form part of the conductive path between tapered conductive cone 33 and tapered counterbore 25, and being deformable will compress in a manner that compensates for machining irregularities or other misalignment, thereby ensuring maximum electrical conduction across this junction under all conditions. Tapered cone 25 and tapered counterbore 33 when mated together provide through compressible conductive element 40 (if used), a conductive path between conductive element 12 and conductive element 16 of plug and socket assemblies 10 and 11, thereby providing an electrical path between the outer conductors of cables C¹ and C². when the respective plug assembly of each is inserted into the ends of the socket assembly. Socket conductive sleeve 16 is further formed with cylindrical element 20 for insertion into bore 39 of socket body 13. Many different and suitable means exist for assuring proper positioning and alignment of socket conductive sleeve 16 within socket body 17, none of which form a novel element of the invention, and any of these, whether now existing or such as may be developed, may be employed without limiting the novel elements of the invention.

As shown in FIGS. 4, 4a and 4b, within central bore 41 of conductive sleeve 16, slotted counterbore CB¹ forms one end of conductive element 23 with slotted counterbore CB² forming the opposing end of conductive element 23, with conductive element 23 providing electrical continuity between respective counterbores. (Alternately, as shown in FIGS. 5, 5a and 5b, conductive element 23 may be fitted with prongs P¹, P², P³ and P⁴, with P¹ and P² attached to one end of conductive element 23 and prongs P³ and P⁴ being attached to the opposing end of conductive element 23, and facing in the opposing direction, with conductive element 23 providing electrical continuity between respective prong pairs.) This arrangement provides the electrical connection between the inner conductors of cable C¹ and cable C². The insulating material forming dielectric support 24 maintains the conductive element 23 and its associated contacts centrally within and electrically insulated from conductive sleeve 16.

In order to assemble a plug assembly onto each cable (C¹ and C²), each cable is prepared as earlier described and inserted into the inner and outer sleeves of a plug assembly (18 and 19). With cable C¹ and C² each fully inserted into a plug assembly, outer sleeve 19 is compressed radially inward to effect sealed engagement between cable C¹ and C², and conductive sleeve 12 of each cable's respective plug assembly, or such other methods consistent with the current state of the art are employed for effecting sealed engagement between cable C¹ and C², and its respective plug assembly 10. Each plug assembly is then inserted in a snap-fit relation into either end of socket assembly 11 with inner conductor E¹ and E²extending through its respective insulating guide ring 22 and coming into contact with the slotted counterbores (or prong pairs) of conductive element 23, and with the tapered counterbore 33 of each plug assembly coming into contact with its respective tapered cone 25 via compressible conductive element 40 (if used) to complete the electrical connection between cable C¹ and socket assembly 11 and thence with cable C². In this relation, an inner continuous conductive path is established between the conductor E¹ of cable C¹, slotted counterbore CB² (or prongs P¹ and P²), conductive element 23, slotted counterbore CB¹ (or prongs P³ and P⁴), and conductor E² of cable C²; and an outer conductive path is established between the outer conductor B¹ of cable C¹ via inner sleeve 18, conductive sleeve 12, tapered counterbore 33, compressible conductive element 40 (if used), tapered cone 25, conductive sleeve 16, tapered cone 25, compressible conductive element 40 (if used), tapered counterbore 33, conductive sleeve 12, inner sleeve 18, and thence to outer conductor B² of cable C². The conductive paths as described are insulated from one another by the dielectric material of the cables (D¹ and D²) and dielectric support 24.

### DETAILED DESCRIPTION OF MODIFIED FORM OF INVENTION

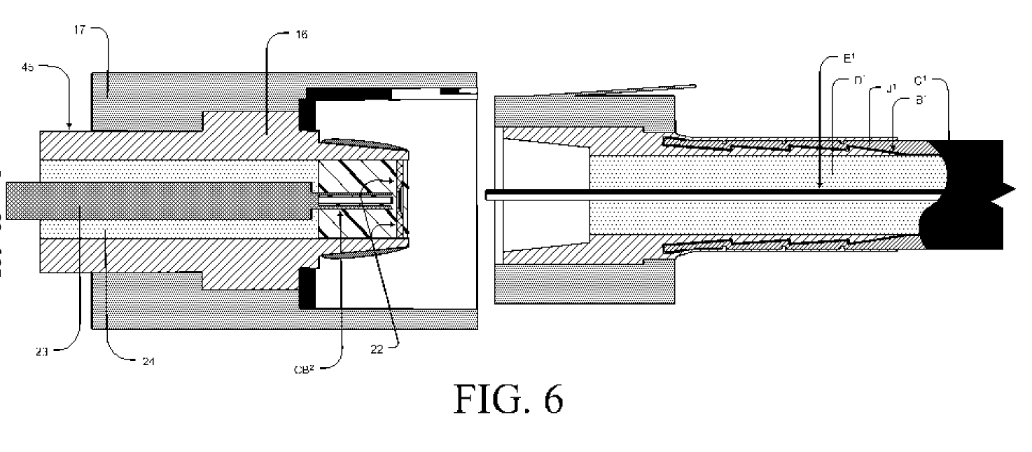

FIG. 6 illustrates another form of socket assembly 11 that is designed for use in connecting a cable to a terminal device or other electronic equipment in a novel and improved manner. For example, coaxial cable C¹ may extend from a wall plate or other equipment with a plug assembly of the type described in the preferred form of the invention attached thereto, and conductive paths must be established between inner conductor E¹ and outer conductor B¹ of cable C¹ and presented within the terminal device or equipment for connection to the circuitry contained therein. To this end, a modified form of socket assembly 11 comprises a socket body 17 and socket conductive element 16 generally corresponding to the form shown in FIG. 6. In this modified form, cylindrical element 45 is provided such that it extends beyond socket body 17. In similar manner, conductive element 23 is extended in length such that it extends past the end of cylindrical element 45. Insulating material is used to form dielectric support 24 that insulates conductive element 23 from cylindrical element 45, and supports conductive element 23 within the central bore of socket conductive element 16 to the rearward most extension of cylindrical element 45. The extended portions of cylindrical element 45 and conductive element 23 are then available for electrical connection to the circuitry of a terminal device or other equipment.

With this modified form of socket assembly 11, cable C1 with plug assembly 10 attached thereto as shown in FIG. 6, may be connected to the terminal device, and electrical/mechanical connections established through socket assembly 11 to the circuitry of the terminal device or equipment. The plug assembly is inserted in a snap-fit relation into socket assembly 11 with inner conductor E¹ extending through insulating guide ring 22 and coming into engagement with slotted counterbore CB², and with tapered counterbore 33 coming into contact with tapered cone 25 though compressible conductive element 40 (if used) to complete the electrical connection between cable C¹, and the extended portions of cylindrical element 45 and conductive element 23 which are available for connection to the circuitry of the terminal. In this relation, an inner continuous conductive path is established between the inner conductor E¹, slotted counterbore CB² and extended conductive element 23; and an outer conductive path is established between the outer conductor B¹ via inner sleeve 18, conductive element 12, tapered counterbore 33, compressible conductive element 40 (if used), tapered cone 25, conductive sleeve 16 and the extended portions of cylindrical element 45.

### DETAILED DESCRIPTION OF SECOND MODIFIED FORM OF INVENTION

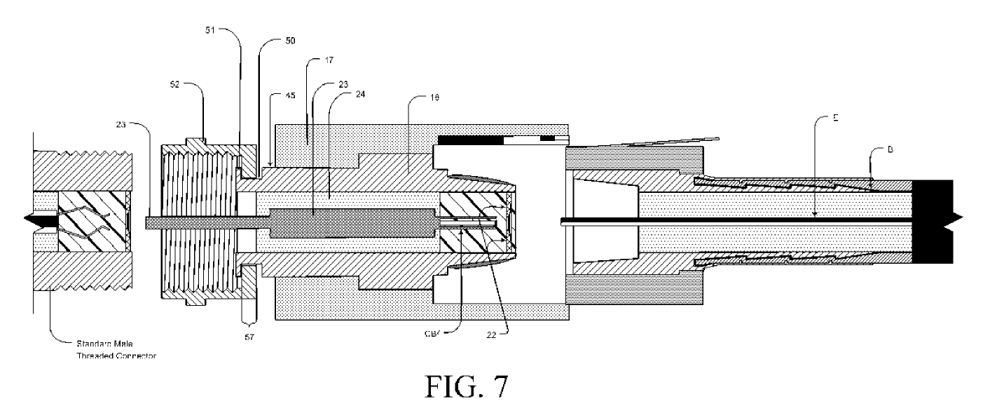

FIG. 7 illustrates another form of socket assembly 11, which is designed for use in adapting a terminal device, or other equipment fitted with a standard male threaded connector for use with the plug assembly described in the preferred form of the invention. For example, coaxial cable C¹ may extend from a wall plate or other equipment with a plug assembly of the type described in the preferred form of the invention attached thereto, and conductive paths must be established between inner conductor E and outer conductor B of the cable and presented within the terminal device or equipment connecting through a standard male threaded connector. To this end, a modified form of socket assembly 11 comprises a socket body 17 and socket conductive element 16 corresponding to the form shown in FIG. 7. In this modified form, cylindrical element 45 is

provided such that it extends beyond socket body 17, reducing in diameter external to socket body 17 as depicted at 50, and then increasing in diameter to form flange 51. Threaded nut 52 is formed with lip 57 such that lip 57 in conjunction with flange 51 retains threaded nut 52 to socket conductive element 16. In similar manner, conductive element 23 is extended in length such that it protrudes past the extended end of cylindrical element 45 and beyond threaded nut 52. Insulating material is used to form dielectric support 24 that insulates conductive element 23 from cylindrical element 45, and supports conductive element 23 within the central bore of socket conductive sleeve 16 to the rearward most extension of cylindrical element 45. Conductive element 23 is sized at all points to match the characteristic impedance of the coaxial cable in use considering the dielectric properties of the surrounding material, if any, the diameter of the corresponding shield and any other factors present that impact the characteristic impedance of coaxial cables. The extended portion of cylindrical element 45, through contact established with threaded nut 52, and the extended portion of conductive element 23 are then available for electrical connection to the complementary elements of a standard male threaded connector, and through said male terminal connector to the circuitry of a terminal device or other equipment.

With this modified form of socket assembly 11, the extended portion of conductive element 23 is inserted into the central opening of a standard male threaded connector until threaded nut 52 contacts the threaded portion of the standard male threaded connector. As threaded nut 52 engages and is tightened upon the threads of the male threaded connector, conductive element 23 is drawn into the male threaded connector establishing contact with the center conductive elements thereof. Threaded nut 52, in combination with cylindrical element 45 establish a connection with the outer shield of the male threaded connector through the complementary and engaged threaded portions of the male threaded connector and threaded nut 52.

Now a cable or other device with plug assembly 10 attached thereto, may be connected to the terminal or other device equipped with a male threaded connector, and electrical/mechanical connections established through socket assembly 11 to the threaded male terminal connector and thence to the circuitry of the terminal device or equipment. The plug assembly is inserted in a snap-fit relation into socket assembly 11 with inner conductor E¹ extending through insulating guide ring 22 and coming into engagement with slotted counterbore CB², and with tapered counterbore 33 coming into contact with tapered cone 25 though compressible conductive element 40 (if used) to complete the electrical connection between cable C¹, and the extended portions of cylindrical element 45 and conductive element 23, making contact with the male terminal connector through threaded nut 52 and insertion of conductive 23 into the central opening of the threaded male terminal connector. In this relation, an inner continuous conductive path is established between the conductor E¹, slotted counterbore CB² and extended conductive element 23; and an outer conductive path is established between the outer conductor B¹ via conductive sleeve 12, tapered counterbore 33, compressible conductive element 40 (if used), tapered cone 25, conductive sleeve 16, the extended portions of cylindrical element 45 and threaded nut 52, to the respective inner and outer conductors of the standard male threaded connector.

### DETAILED DESCRIPTION OF THIRD MODIFIED FORM OF INVENTION

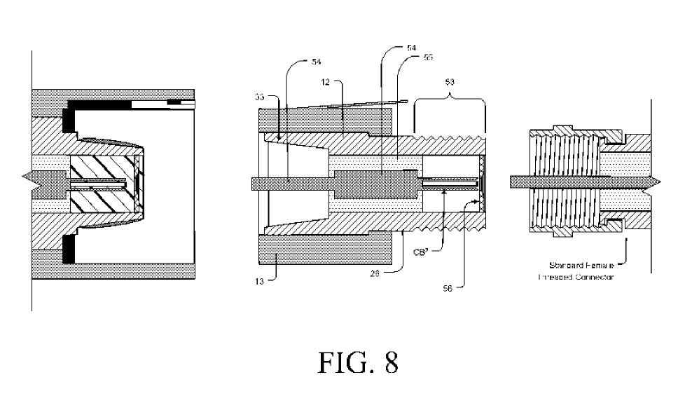

FIG. 8 illustrates another form of plug assembly 10, which is designed for use in adapting a cable, or other electronic equipment equipped with a standard female threaded connector for use with the socket assembly described in the preferred and modified forms of the invention. For example, a cable, terminal device or other electronic equipment may be fitted with a socket assembly as described in the preferred and modified forms of the invention as depicted in FIG. 1, 4, 4a, 4b, 5, 5a, 5b and 6, and a cable or other device fitted with a standard female threaded connector, requires connection to said equipment such that conductive paths must be established between inner conductor and the outer conductor of the standard female threaded connector and presented to the socket assembly, and thence to the circuitry or other device connected thereto. To this end, a modified form of plug assembly 10 comprises a plug body 17 and plug conductive sleeve 12 corresponding to the form shown in FIG. 8. In this modified form, cylindrical element 26 is lengthened such that it extends beyond plug body 13, and having external threads 53 sufficient for engaging the complementary threads of a standard threaded female connector. In this modified plug assembly, conductive element 12 is fitted with conductive components similar to those found in the second modified form of the socket assembly of the invention element, which components are fitted into the central opening of plug conductive element 12. The conductive components located within plug conductive element 12 are comprised of conductive element 54 that extends beyond tapered conductive cone 33 with sufficient length for connecting physically and electrically to the central conductive elements of a receiving socket assembly. The opposing end of conductive element 54 is fitted with a slotted counterbore CB² (or prongs) for receiving the center conductor of the standard threaded female connector. Insulating material is used to form dielectric support 55 that insulates conductive element 54 from conductive element 12 throughout its length, and supports conductive element 23 within the central bore thereof as shown. Conductive element 23 is sized at all points to match the characteristic impedance of the coaxial cable in use considering the dielectric properties of the surrounding material, if any, the diameter of the corresponding outer conductor and any other factors present that impact the characteristic impedance of coaxial cables. The end of the extended portion of cylindrical element 26 is fitted with insulating guide ring 56 located within the central opening of plug conductive sleeve 12.

With this modified form of plug assembly 10, the center conductor from a standard female threaded connector is inserted through insulating guide ring 56 until the threaded nut of the threaded female connector contacts the threaded end 53 of cylindrical element 26. By engaging, rotating and tightening the threaded nut of the standard female connector upon threaded end 53, the center conductor of said connector is drawn fully into mechanical and electrical engagement with slotted counterbore CB³ and conductive element 54. The threaded nut of the standard threaded female connector, in combination with threaded end 54 establishes a connection between the outer shield of the cable or other equipment and plug conductive sleeve 12.

Now a cable or other equipment fitted with a standard threaded female connector may be connected to a cable or other device equipped with a socket assembly as described in preferred and modified forms of the invention, and electrical/mechanical connections established through the modified plug assembly to a socket assembly and thence to the cable, terminal device or other equipment connected to said socket assembly. This modified plug assembly is inserted in a snap-fit relation into socket assembly 11 with the extended portion of conductive element 54 passing through insulating guide ring 22 and coming into engagement with slotted counterbore CB², and with tapered counterbore 33 coming into contact with tapered cone 25 though compressible conductive element 40 (if used) to complete the electrical connection for the inner and outer conductors respectively. In this relation, an inner continuous conductive path is established between the center conductor of the standard female threaded connector, slotted counterbore CB³, extended conductive element 54 and counterbore CB²; and an outer conductive path is established between the outer conductor of the standard female threaded connector via the treaded portion 53 of cylindrical element 26, conductive sleeve 12, tapered counterbore 33, compressible conductive element 40 (if used), tapered cone 25 and conductive sleeve 16 to the respective inner and outer conductors of the cable, terminal or equipment equipped with socket assembly 11.

### DETAILED DESCRIPTION OF ALTERNATE FORM OF INVENTION

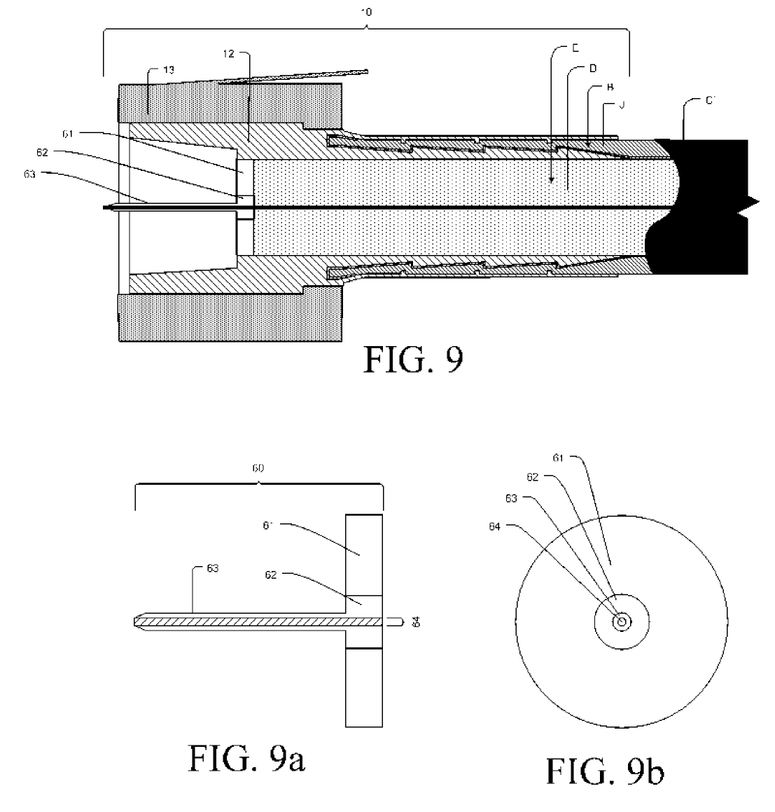

FIGS. 9, 9a and 9b illustrates an alternate form of plug assembly 10, which is designed for use with cables having an inner conductor that is insufficiently rigid to maintain proper alignment for insertion into a socket assembly. For example, a cable may have an inner conductor that is made from a soft material, such as pure copper, or that may be comprised of braided copper strands, or that may be made of a sufficiently small diameter so as to flex and deform upon insertion through the guide ring(s), and upon contacting the central conductive elements of a socket assembly as depicted in preferred and modified forms of the invention. In such instances, an adaptive element must be employed to provide sufficient rigidity for the center conductive element and thereby permit insertion into a socket assembly in a proper alignment to establish mechanical and electrical connection while maintaining the characteristic impedance of the coaxial cable. To this end, a modified form of plug assembly 10 comprises a plug body 17 and plug conductive sleeve 12 corresponding to the form shown in FIG. 9. In this modified form, plug adapter 60, which is comprised of dielectric element 61, center conductive element 62 and extended conductive pin 63 with central bore 64, forms an additional element of plug assembly 10 capable of providing the rigidity and length necessary for mechanical and electrical engagement with a socket assembly.

As more clearly shown in FIGS. 9a and 9b, plug adapter 60 consists of a central conductive element 62 and conductive pin 63 which are centrally positioned in dielectric element 61. Dielectric element 61 electrically insulates conductive element 62 from conductive sleeve 12 while also positioning conductive element 62 and conductive pin 63 as required for maintaining the characteristic impedance of the coaxial cable. Central bore 64 extends through conductive element 62 and conductive pin 63 for the length thereof and is sized to permit insertion of the inner conductor of cable C¹. The physical size and material composition for all elements of plug adapter 60 are selected, shaped and assembled for maintaining the character impedance of the coaxial cable.

With this modified form of plug assembly 10, a coaxial cable is prepared as earlier described in the preferred form of the invention, taking care to expose a sufficient length to pass completely through central bore 64. Plug adaptor 60 is then applied to the cable, passing the exposed center conductor through central bore 64, with dielectric element 61 positioned against the end of exposed dielectric D of cable C¹. The electrical and mechanical connection between inner conductor E of cable C¹ and central conductive element 62, including extended pin 63, is completed by conventional means including, but not limited to soldering, crimping, extrusion or compressible insert, taking care to remove any excess inner conductor protruding from extended pin 63. With plug adapter 60 assembled onto cable C¹, it is ready for insertion into the inner and outer sleeves of plug assembly 10. With cable C¹ fully inserted into plug assembly 10, outer sleeve 19 is compressed radially inward to effect sealed engagement between cable C¹, and conductive sleeve 12 of plug assembly 10, or such other methods are employed, consistent with the current state of the art, for effecting sealed engagement between cable C¹ and plug assembly 10. Cable C¹ is now ready for connection to a socket assembly as shown in preferred and modified forms of the invention. In this relation, an inner continuous conductive path is established between the conductor E of cable C¹, central conductive element 62 and presented in extended pin 63 for electrical connection within a socket assembly; and an outer conductive path is established between the outer conductor B of cable C¹ via inner sleeve 18, conductive sleeve 12 and presented for connection to a socket assembly via tapered counterbore 33. The conductive paths as described are insulated from one another by the dielectric material of the cable (D) and dielectric element 61.

It is therefore to be understood that while preferred and modified forms of invention are herein set forth and described, various modifications and changes may be made in the construction and arrangement of parts as well as composition of materials without departing from the spirit and scope of the present invention as defined by the appended claims.

What is claimed is:

1. A modular connector assembly for connecting coaxial cable together wherein said cable has radially inner and outer conductors separated by an annular dielectric, in some cases a tubular jacket encasing said outer conductor and a portion of said inner conductor being exposed at the end of said cable, said assembly comprising:
(a) a plug connector having radially inner and outer spaced coaxial sleeves, said inner sleeve being sized for insertion of said inner conductor and said annular dielectric therein, said outer sleeve being sized for insertion of said outer conductor and said jacket, if any, through one end of said connector between said inner and outer sleeves;
(b) said plug connector having a body with at least one locking tab, at least one locking release tab, at least one guide surface, a central bore and a central counterbore;
(c) said plug connector having a hollow generally cylindrical portion, a tapered cone at one end of said cylindrical portion and a conductor member extending concentrically within said cylindrical portion;
(d) said cylindrical portion of said plug connector forming the outer conductor of said plug connector;
(e) a socket connector having radially inner and outer spaced coaxial sleeves, said inner sleeve being sized for insertion of said inner conductor and said annular dielectric therein, said outer sleeve being sized for insertion of said outer conductor and said jacket, if any, through one end of said connector between said inner and outer sleeves;
(f) said socket connector having a body with at least one guide surface, mating cavity, at least one locking cavity, at least one locking tab release slot, a central bore and a central counterbore;
(g) said socket connector having a hollow generally cylindrical portion, a tapered counterbore at one end of said cylindrical portion and a central conductive member with central counterbores at opposing ends thereof and said conductive element placed concentrically within said cylindrical portion;
(h) said cylindrical portion of said socket connector forming the outer conductor of said socket connector;
(i) said central conductive member of said socket connector forming the inner conductor of said socket connector;
(j) said inner and outer conductors of said plug connector and said socket connector including complementary end portions for positively connecting said inner and outer conductors positively;
(k) said plug and socket assembly employing a compressible conductive element placed between the tapered cone of said plug connector and the tapered counterbore of said socket assembly forming part of the outer conductor of said plug assembly and said socket assembly;
(l) said cylindrical portion of said plug connector being fixed within said plug body;
(m) said cylindrical portion of said socket connector being fixed within said socket body; and
(n) said central conductive member of said socket connecter having central counterbores at opposing ends thereof;
(o) whereas the improvement is said socket assembly having mating cavities for receipt of said plug assembly at the two ends thereof;
(p) said socket body of said socket assembly having at least two guide surfaces, one each at the two ends thereof;
(q) said outer conductor of said socket connector having a tapered cone at each end thereof complimentary to the tapered counterbore of said plug assembly;
(r) said outer conductor of said plug connector having a tapered counterbore at one end thereof complimentary to the tapered cone of said socket assembly.

2. A connector assembly according to claim 1, said plug assembly directly connecting to a coaxial cable.

3. A connector assembly according to claim 1, said plug connecting end portion and said socket connecting end portion having complementary mating cavities and guide surfaces.

4. A connector assembly according to claim 1, wherein a compressible conductive element may be employed in either the plug assembly or the socket assembly, said compressible conductive element being employed to maintain electrical and mechanical connection between the outer conductors of said plug assembly and said socket assembly.

5. A connector assembly according to claim 1, wherein said plug assembly and said socket assembly each employ a cylindrical conductive sleeve, wherein the conductive sleeve of said socket assembly is generally fixed within the socket body, and the conductive sleeve of said plug assembly may be either fixed or longitudinally movable within said plug body.

6. A connector assembly according to claim 1, wherein the socket assembly is configured to receive said plug assembly in each opposing end thereof.

7. A connector assembly according to claim 1, wherein said central conductive element of said socket assembly employs either central counterbores or prongs to engage the inner conductor of said plug assembly.

8. A terminal connector assembly for connecting an end of a coaxial cable or other device to a terminal wherein said cable has radially inner and outer conductors separated by an annular dielectric, in some cases a tubular jacket encasing said outer conductor and a portion of said inner conductor being exposed at the end of said cable, said assembly comprising:
(a) a plug connector having radially inner and outer spaced coaxial sleeves, said inner sleeve being sized for insertion of said inner conductor and said annular dielectric therein, said outer sleeve being sized for insertion of said outer conductor and said jacket through one end of said connector between said inner and outer sleeves;
(b) said plug connector having a body with at least one locking tab, at least one locking release tab, at least one guide surface, a central bore and a central counterbore;
(c) said plug connector having a hollow generally cylindrical portion, a tapered cone at one end of said cylindrical portion and a conductor member extending concentrically within said cylindrical portion;
(d) said cylindrical portion of said plug connector forming the outer conductor of said plug connector;
(e) said socket connector having a body with at least one guide surface, mating cavity, at least one locking cavity, at least one locking tab release slot, a central bore and a central counterbore;
(g) said socket connector having a hollow generally cylindrical portion, a tapered counterbore at one end of said cylindrical portion and a central conductive member with a counterbore at one end, said conductive element placed concentrically within said cylindrical portion;
(h) said central conductive member extending through said socket body such that electrical connection may be made to said central conductor within a terminal device;
(i) said cylindrical portion of said socket connector forming the outer conductor of said socket connector;
(j) said central conductor of said socket connector extending through said socket body such that electrical connection may be made to said central conductor within a terminal device;
(k) said inner and outer conductors of said plug connector and said socket connector including complementary end portions for positively connecting said inner and outer conductors positively;
(l) said plug assembly and said socket assembly employing a compressible conductive element placed between the tapered cone of said plug connector and the tapered counterbore of said socket assembly forming part of the outer conductor of said plug assembly and said socket assembly;
(m) said cylindrical portion of said plug connector being fixed within said plug body;
(n) said cylindrical portion of said socket connector being fixed within said socket body;
(o) said central conductive member of said socket connecter having central counterbores at opposing ends thereof;
(p) whereas the improvement is said socket assembly having a mating cavity for receipt of said plug assembly at one end thereof;
(q) said outer conductor of said socket connector having a tapered cone at one end thereof;
(r) said socket assembly having a central conductive element employing either central counterbore or prongs to engage the inner conductor of said plug assembly.

9. A connector assembly for adapting a standard male threaded connector to a socket assembly for connecting an end of a coaxial cable or other device to a device wherein said cable or other device is equipped with a plug assembly wherein said cable or other device has radially inner and outer conductors separated by an annular dielectric, in some cases a tubular jacket encasing said outer conductor and a portion of said inner conductor being exposed at the end of said cable, said assembly comprising:
(a) a plug connector having radially inner and outer spaced coaxial sleeves, said inner sleeve being sized for insertion of said inner conductor and said annular dielectric therein, said outer sleeve being sized for insertion of said outer conductor and said jacket, if any, through one end of said connector between said inner and outer sleeves;
(b) said plug connector having a body with at least one locking tab, at least one locking release tab, at least one guide surface, a central bore and a central counterbore;
(c) said plug connector having a hollow generally cylindrical portion, a tapered cone at one end of said cylindrical portion and a conductor member extending concentrically within said cylindrical portion;
(d) said cylindrical portion of said plug connector forming the outer conductor of said plug connector;
(e) said socket connector having a body with at least one guide surface, mating cavity, at least one locking cavity, at least one locking tab release slot, a central bore and a central counterbore;
(g) said socket connector having a hollow generally cylindrical portion, a tapered counterbore at one end of said cylindrical portion and a flange at the opposing end thereof to retain a threaded nut thereto, and a central conductive member with a counterbore at one end and an extended pin at the opposing end thereof, said conductive element placed concentrically within said cylindrical portion;
(h) said central conductive member extending through said threaded nut such that electrical connection may be made to the center conductor of said standard male threaded connector;
(i) said cylindrical portion and said threaded nut of said socket connector forming the outer conductor of said socket connector;
(j) said outer conductor of said socket connector extending through said socket body such that electrical connection may be made to said outer conductor of said standard male threaded connector;
(k) said inner and outer conductors of said plug connector and said socket connector including complementary end portions for positively connecting said inner and outer conductors positively; and
(l) a compressible conductive element placed between the tapered cone of said plug connector and the tapered counterbore of said socket assembly forming part of the outer conductor of said plug assembly and said socket assembly;
(m) whereas the improvement is said socket assembly having a mating cavity for receipt of said plug assembly at one end thereof;
(n) said outer conductor of said socket connector having a tapered cone at one end thereof;
(o) said socket assembly having a central conductive element employing either a central counterbore or prongs to engage the inner conductor of said plug assembly.

10. A connector assembly for adapting a standard female threaded connector to a plug assembly for connecting an end of a coaxial cable or other device to a device wherein said device is equipped with a socket assembly wherein said device has radially inner and outer conductors separated by an annular dielectric, in some cases a tubular jacket encasing said outer conductor and a portion of said inner conductor being exposed at the end of said device, said assembly comprising:
(a) a plug connector having a body with at least one locking tab, at least one locking release tab, at least one guide surface, a central bore and a central counterbore;
(b) said plug connector having a hollow generally cylindrical portion, a tapered cone at one end of said cylindrical portion and external threads on the opposing end thereof, a central conductive member with a counterbore at one end and an extended pin at the opposing end thereof, said conductive element placed concentrically within said cylindrical portion;
(c) said cylindrical portion of said plug connector forming the outer conductor of said plug connector;
(d) said central conductive member of said socket connector forming the inner conductor of said plug connector;
(e) said socket connector having a body with at least one guide surface, mating cavity, at least one locking cavity, at least one locking tab release slot, a central bore and a central counterbore;
(g) said socket connector having a hollow generally cylindrical portion, a tapered counterbore at one end of said cylindrical portion, and a central conductive member with a counterbore at one or both ends, said conductive element placed concentrically within said cylindrical portion;
(h) said central conductive member of said socket connector forming the outer conductor of said socket connector;
(i) said central conductive member extending through said cylindrical portion such that electrical connection may be made to the center conductor of said cable or device;
(j) said cylindrical portion of said socket connector forming the outer conductor of said socket connector;
(k) said outer conductor of said socket connector extending through said socket body such that electrical connection may be made to said outer conductor of said cable or device;
(l) said inner and outer conductors of said plug connector and said socket connector including complementary end portions for positively connecting said inner and outer conductors positively; and
(m) a compressible conductive element placed between the tapered cone of said plug connector and the tapered counterbore of said socket assembly forming part of the outer conductor of said plug assembly and said socket assembly;
(n) whereas the improvement is said plug assembly having a tapered counterbore at one end thereof complimentary to the tapered cone of said socket assembly.

11. A plug assembly for use with a cable having a flexible inner conductor wherein said cable has radially inner and outer conductors separated by an annular dielectric, in some cases a tubular jacket encasing said outer conductor and a portion of said inner conductor being exposed at the end of said cable, said assembly comprising:
(a) a plug connector having radially inner and outer spaced coaxial sleeves, said inner sleeve being sized for insertion of said inner conductor and said annular dielectric therein, said outer sleeve being sized for insertion of said outer conductor and said jacket, if any, through one end of said connector between said inner and outer sleeves;
(b) said plug connector having a body with at least one locking tab, at least one locking release tab, at least one guide surface, a central bore and a central counterbore;
(c) said plug connector having a hollow generally cylindrical portion, a tapered cone at one end of said cylindrical portion and a conductor member extending concentrically within said cylindrical portion;
(d) said cylindrical portion of said plug connector forming the outer conductor of said plug connector;
(e) said plug connector having a plug adaptor with a dielectric element, center conductive element and an extended conductive pin;
(f) said extended conductive pin having a central bore for receipt of said flexible inner conductor of said cable;
(g) said extended conductive pin providing the necessary rigidity to said flexible inner conductor;
(h) said dielectric element insulating said center conductive element from said outer conductor of said conductive sleeve.
